(19) United States
(12) Patent Application Publication
(10) Pub. No.: US 2026/0300949 A1
(43) Pub. Date: Oct. 1, 2026

(54) IMAGE ACQUISITION AND DECODING PROCESSES FOR DATA READING SYSTEMS

(71) Applicant: Datalogic IP Tech S.r.l., Lippo di Calderara di Reno (Bologna) (IT)

(72) Inventor: WenLiang GAO, Eugene, OR (US)

(21) Appl. No.: 19/094,639

(22) Filed: Mar. 28, 2025

(51) Int. Cl. G06Q 20/20; G06T 5/40; G06T 9/00

(52) U.S. Cl. CPC G06Q 20/208; G06T 5/40; G06T 9/00

(57) ABSTRACT

The disclosure relates to a data reading system and related methods of operation designed for optimizing and efficiently handling various image-processing functionalities of a data reading system. The data reading system includes one or more data readers that are configurable between a first operating mode with a first image capture frame rate and a second operating mode with a second image capture frame rate for capturing image data for decoding any optical codes contained therein. The operating modes of the data reading system may be toggled to optimize image acquisition capabilities while minimizing overall processing load.

### BACKGROUND

The present disclosure relates generally to data reading systems, such as scanners or code readers, and more particularly, to fixed retail scanners designed for efficiently handling image-processing functionalities to optimize image acquisition capabilities while minimizing overall processing load.

Data reading systems are used in retail settings and a variety of other environments for reading optical codes, capturing images of items, and/or acquiring other suitable data from items for processing. In an example retail environment, data reading devices are well known for reading (typically via monochrome image sensors) UPC and other types of optical codes, such as barcodes, digital watermarks, etc., on grocery items or packages to process the item for purchase during a checkout process. Some data reading systems are equipped with more advanced imaging technologies that can be used for item and produce recognition, item verification, and other security applications during the checkout process. In self-checkout systems, these advanced features may be particularly advantageous to ensure proper item processing and avoid or minimize losses from retail theft or inadvertent processing errors by customers.

Some conventional data reading systems include multiple data readers or imagers for accomplishing various data reading tasks. For example, a data reading system may include one or more monochrome imagers optimized for acquiring images and decoding optical codes therefrom, and may also include one or more color imagers optimized for acquiring item images for more advanced imaged analysis, such as for item recognition and security applications as described above. Typically, monochrome imagers and color imagers operate under different conditions to ensure they are each optimized for their respective task. For example, a monochrome imager for optical code reading typically uses active illumination sources (e.g., LEDs) at very short exposure times and illumination pulse (e.g., 100 μs-200 μs) to minimize motion blur. On the other hand, a color imager for item recognition and related applications typically uses ambient light for more even light distribution on the target and tolerates motion blur, so it requires automatic exposure control (AEC) and longer maximum exposure times (e.g., 10 ms-50 ms) to allow for more ambient light.

In some data reading systems, exposure and illumination characteristics, among other features, may be controlled and adjusted by an image processing system to optimize the image-acquisition process based on the environment of use. For example, data reading systems may include capabilities to adjust frame rates, exposure times, and illumination settings, among other parameters, as needed to allow the imagers to capture images for decoding optical codes and achieve an acceptable read rate while maintaining desired scanner performance.

For fixed barcode scanners in a retail environment, a high first-pass read rate is desirable to expedite transactions and minimize transaction processing times for customers. In some examples, to achieve a high first-pass read rate, conventional data reading systems may configure imagers to operate at high frame rates (e.g., 90 fps) to capture item images and accommodate a high item sweep speed across the data reader during item processing. Reliance on high frame rates, however, typically requires higher power consumption and processing loads for the data reading system to maintain an optimal performance level. Alternatively, a data reading system designed to capture images at a lower frame rate may reduce the overall processing load for handling the image data. However, a lower frame rate typically results in a reduced first pass read rate, and items must be processed at a lower sweep speed to ensure the images can capture images for successful decoding.

Accordingly, the inventor has identified a need for an improved data reading system designed for accommodating image capture at higher frame rates to maximize a first pass read rate while also minimizing overall image processing loads for the data reading system. Additional aspects and advantages of such systems will be apparent from the following detailed description of example embodiments, which proceed with reference to the accompanying drawings.

Understanding that the drawings depict only certain embodiments and are not, therefore, to be considered limiting in nature, these embodiments will be described and explained with additional specificity and detail with reference to the drawings.

### BRIEF DESCRIPTION OF THE DRAWINGS

FIG. 1 illustrates an example data reading system operable for scanning items and processing a purchase transaction in accordance with one embodiment.

FIG. 2 is a simplified block diagram illustrating components of a data reading system in accordance with one embodiment.

FIG. 3 is a simplified illustration of an example single-plane data reading system in accordance with one embodiment.

FIG. 4 is an example timing diagram charting image capture, illumination, and processing functionalities in accordance with one embodiment.

FIG. 5 is another example timing diagram charting image capture, illumination, and processing functionalities in accordance with one embodiment.

FIG. 6 is an example flowchart illustrating a method for toggling between data reader processing modes in accordance with one embodiment.

FIG. 7A is an example image taken at a first time in accordance with one embodiment.

FIG. 7B is an example histogram generated for the image of FIG. 7A.

FIG. 8A is another example image taken at a second time in accordance with one embodiment.

FIG. 8B is an example histogram generated for the image of FIG. 8A.

FIG. 9A is another example image taken at a third time in accordance with one embodiment.

FIG. 9B is an example histogram generated for the image of FIG. 9A.

FIG. 10A is another example image taken at a fourth time in accordance with one embodiment.

FIG. 10B is example histogram generated for the image of FIG. 10A.

FIG. 11 illustrates cross-correlation peak value data based on an analysis of the image histograms of FIGS. 7A-10B in accordance with one embodiment.

### DETAILED DESCRIPTION OF DISCLOSED EMBODIMENTS

With reference to the drawings, this section describes specific embodiments relating to a data reading system and its detailed construction and operation. The embodiments described herein are set forth by way of illustration only and not limitation. The described features, structures, characteristics, and methods of operation may be combined in any suitable manner in one or more embodiments. In view of the disclosure herein, those skilled in the art will recognize that the various embodiments can be practiced without one or more of the specific details or with other methods, components, materials, or the like. In other instances, well-known structures, materials, or methods of operation are not shown or not described in detail to avoid obscuring more pertinent aspects of the embodiments.

With collective reference to the figures, the following disclosure generally relates to a data reading system, such as a self-checkout system or other suitable point-of-sale system, that may be used in a retail setting to capture and process image data during a customer transaction for the purchase of various goods offered in a retail facility. The data reading system may include any suitable data readers operable for capturing image data from an item and any suitable reading engine configuration for decoding the captured image data to complete a retail transaction.

As mentioned previously and further described in detail below, some conventional data reading systems typically include one or more imaging devices set to capture images at a high frame rate to improve first pass read rate at the cost of high processing power requirements. Other conventional data reading systems are set to capture images at a lower frame rate to minimize overall processing load at the cost of a reduced first pass read rate and other image processing capabilities. The embodiments described herein with reference to the figures relate to an improved data reading system operable for efficiently processing images captured at high frame rates (e.g., 90 fps) for improved image acquisition and processing functionalities while also designed to conserve overall processing power to minimize cost and streamline performance.

As further described below, in one embodiment, the data reading systems described herein are configured to toggle between: (a) a monitoring mode—where the imagers are configured to capture images at a high frame rate to accommodate a high item sweep speed when the data reading system detects the presence of an item in the field-of-view; and (b) a triggered mode—where the imager settings are downscaled and set to capture images at a lower frame rate for image acquisition and decoding. The triggered mode continues for a predefined period of time to help offset the higher power requirements of the monitoring mode and improve the overall energy efficiency of the data reading system. Additional details of these and other embodiments of the data reading system and related methods are further discussed below with reference to the accompanying figures.

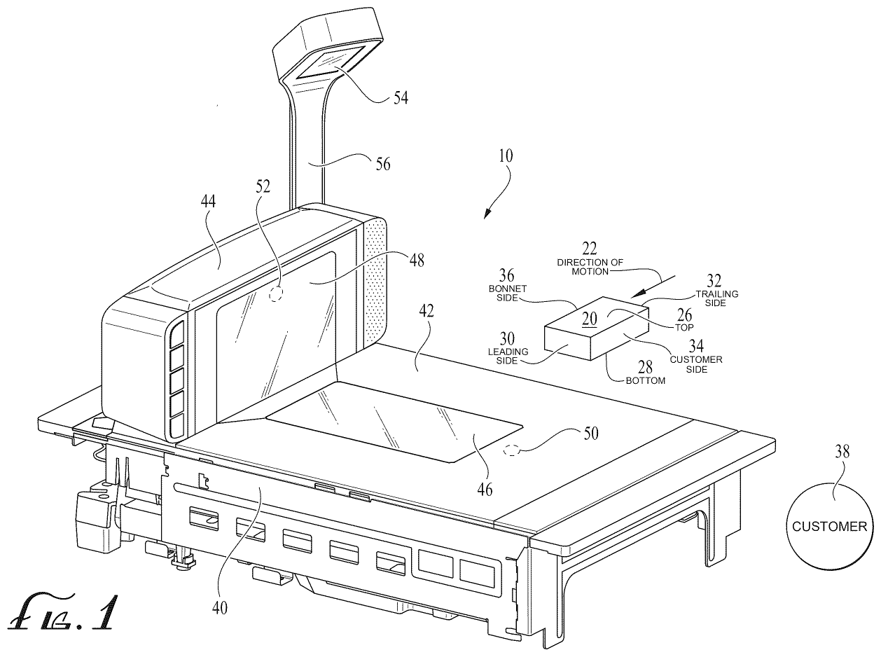

FIG. 1 illustrates an example embodiment of a data reading system 10 in accordance with one embodiment. For general reference, the following section briefly describes general components of the data reading system 10 and provides an example operation of the data reading system 10 when used in a retail establishment to process a transaction. With reference to FIG. 1, the data reading system 10 is used to scan, weigh (as needed), and pay for items 20 as part of a customer transaction. In some embodiments, the data reading system 10 may be designed as a self-checkout system for processing transactions without the need for assistance by store clerk or other personnel. In other embodiments, the data reading system 10 may instead be incorporated into a checkout counter operated by a clerk. For discussion purposes, it should be understood that while the drawings and relevant discussion may reference the data reading system 10 as a self-checkout system, embodiments of the disclosure also include systems that may be operated by a store clerk in an assisted checkout lane environment. Thus, it should be understood that references to “customer” are also applicable to a “clerk” or “operator” who may be the user of the data reading system 10 in certain situations. In addition, the scope of the disclosure incorporates other configurations for data reading systems that incorporate a scale.

As illustrated in FIG. 1, the data reading system 10 is operable to obtain information (e.g., optical codes, images, etc.) from an example six-sided item 20 (e.g., a grocery item) that is passed along a direction of motion 22 through a read region of the data reading system 10. For general purposes of discussion, the item 20 is represented in the figures as a six-sided, box-shaped package having a top surface 26, a bottom surface 28, a leading side 30, a trailing side 32, a customer side 34, and a bonnet side 36. While the item 20 is illustrated and described as a box-shaped package for convenience, it should be understood that the item 20 may encompass other shapes, including, for example, round fruits or vegetables, cylindrical cans, irregularly shaped packages, such as a bag of potatoes, potato chips, or the like.

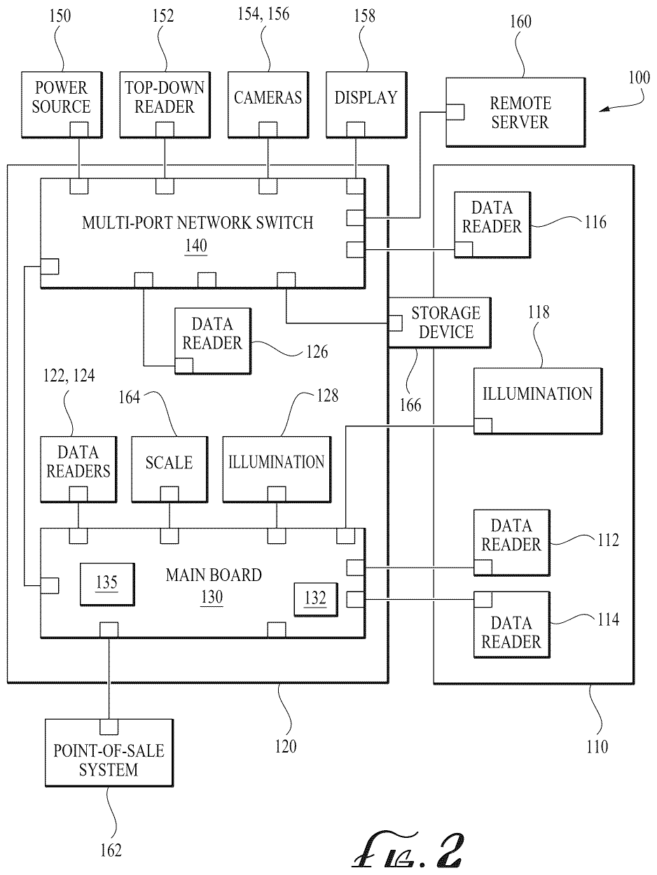

As illustrated, the data reading system 10 may be a two-plane or bi-optic fixed retail scanner having a housing that includes a lower base section 40 supporting a platter 42, and a bonnet or raised upper section 44 extending from and protruding upwardly from the platter 42 (and the lower base section 40). The data reading system 10 may further includes a scale 164 (see FIG. 2) disposed underneath the platter 42 and within the lower base section 40, where the scale 164 includes load cells or receptors operable to weigh the item 20 (such as for items sold by weight) when the item 20 rests against the top surface of the platter 42. In some embodiments, the scale 164 may be incorporated into or otherwise operable in conjunction with the platter 42.

The data reading system 10 includes one or more data readers 50 housed within lower base section 40 underneath the platter 42, and the bonnet 44 may further include one or more data readers 52 housed therein. The data readers 50, 52 are arranged within the platter 42 and bonnet 44, respectively, to project their fields-of-view through the respective windows 46, 48 to capture image or other suitable data for decoding an optical code on the item 20 as it moves through the combined read region of the data readers 50, 52 of the data reading system 10. In some embodiments, the data reading system 10 may incorporate mirrors or any other suitable optical components (not shown in FIG. 1) within the lower base section 40 and bonnet 44 to ensure the respective fields-of-view of the data readers 50, 52 are directed as needed to capture data from the item 20. In other embodiments, the data reading system may be a single plane reader without a bonnet or may have other suitable configurations, including having a top-down data reader (see 152 of FIG. 2) that includes a stand extending upwardly from the lower base section 40 and above the bonnet 44. The top-down data reader includes a head with one or more data readers therein arranged to project a field-of-view from an elevated position downwardly onto the platter 42.

The data reading system 10 may further include a top-down data reader (TDR) 54 that includes a post section 56 extending upwardly from the housing 40 to any suitable height such that the TDR 54 extends above the bonnet 44 and provides an overhead view of the read region and the platter 42 to complement the view of the internal data readers 50, 52. Like the data readers 50, 52, TDR 54 is operable to capture image data for an item 20 as it moves through the read region and the platter 42 of the data reading system 10.

For purposes of this disclosure, reference to a “data reader” is used in an expansive sense to describe any suitable device (or combination of devices) capable of obtaining image data and/or other suitable data from an item 20 in a field-of-view of the device. The captured data may thereafter be used for decoding coded information from an item 20 and/or for accomplishing any other suitable purpose related to the data reading system 10. In some embodiments, a data reader may include a camera or other suitable imaging system, a processor, a decoding unit, and a controller for communicating data to other data readers or external systems for processing. In other embodiments, the data reader may include a subset of these components within a common housing and other components may be external to the data reader itself. For example, in one embodiment, the data readers may each include an imager designed to obtain images of the item 20 and to communicate those images to the decoding unit (which may be part of the processor) in an external database for decoding the coded information captured in the images and identify the item 20. Likewise, reference to a “color data reader” may include a similar imager-based or other suitable system as described above operable to capture and/or process color image data from objects within its field-of-view.

“Image data” as used herein may include raw images as well as processed images (e.g., cropped, compressed, etc.) from the raw images as well as other forms of data derived from raw image data that provides useful information for image analysis, such as descriptor data, histogram data, etc. Image data may include both individual image frames as well as multiple frames (e.g., streaming video). In some embodiments, raw images may include information arranged in two dimensions which are the x (width) and y (height) coordinates of a 2D sensor. The information at each x, y coordinate may include monochrome data, RGB data, depth data, multi-spectral data, infrared data, etc. as well as combinations thereof (e.g., RGB-depth may be captured by 3D cameras). Image data may be captured by one or more imagers arranged at various positions within the housing of the data reading system, such as in a horizontal base unit or a vertical bonnet of a bi-optic data reader having imagers positioned in two different planes. Single plane scanners (see FIG. 3 for example) having only a horizontal or vertical housing are also contemplated and are within the scope of the disclosure. Image data may also be captured by one or more imagers positioned external to the primary scanning unit, such as peripheral devices (e.g., top-down reader imagers, security imagers, bottom of basket readers, etc.) that may also provide image data to the fixed retail scanner and/or remote systems. In some cases, image data and images may be used interchangeably herein.

The data readers 50, 52, 54 may include any suitable decoding algorithms to decode coded information from the item 20 that may be contained within one-dimensional codes, two-dimensional codes, stacked codes, or other code configurations. In this disclosure, the data readers 50, 52, 54 may be referenced as including imagers or imaging systems, but it should be understood that the reference is meant to provide an example configuration for the data readers. Other data reading systems and data reader configurations may be used without departing from the principles of the disclosed subject matter. Examples of various configurations include those described in any of the following: U.S. Pat. No. 8,430,318, issued Apr. 30, 2013, and entitled “SYSTEM AND METHOD FOR DATA READING WITH LOW PROFILE ARRANGEMENT,” U.S. Pat. No. 9,004,359, issued Apr. 14, 2015, entitled “OPTICAL SCANNER WITH TOP DOWN READER,” U.S. Pat. No. 9,305,198, issued Apr. 5, 2016, entitled “IMAGING READER WITH IMPROVED ILLUMINATION,” U.S. Pat. No. 10,049,247, issued Aug. 14, 2018, entitled “OPTIMIZATION OF IMAGE FRAME MANAGEMENT IN A SWEEP-STYLE OPTICAL CODE DATA READER,” U.S. Pat. No. 10,248,896, issued Apr. 2, 2019, and entitled “DISTRIBUTED CAMERA MODULES SERIALLY COUPLED TO COMMON PREPROCESSING RESOURCES FACILITATING CONFIGURABLE OPTICAL CODE READER PLATFORM FOR APPLICATION-SPECIFIC SCALABILITY,” and U.S. Pat. No. 10,970,502, issued Apr. 6, 2021, and entitled “DATA COLLECTION SYSTEMS AND METHODS TO CAPTURE IMAGES OF AND DECODE INFORMATION FROM MACHINE-READABLE SYMBOLS,” and U.S. Pat. No. 12,045,686, issued Jul. 23, 2024, and entitled “FIXED RETAIL SCANNER WITH MULTI-PORT NETWORK SWITCH AND RELATED METHODS, the disclosure of each of which is incorporated by reference herein in its entirety.

With reference to FIG. 1, the following provides an example operation of the data reading system 10 in accordance with one embodiment. During a transaction, the item 20 is swiped across the platter 42, that is, the item 20 is moved along the direction of motion 22 across the platter 42 above the horizontal scan window 46 and in front of the vertical scan window 48. As the item 20 is swiped across the scan windows 46, 48, the data readers 50, 52, 54 cooperate to obtain image data for all sides of the item 20 to find and decode the optical code from the image data. For example, if the optical code (or other target data) is present on the bonnet side surface 36 of the item 20, the data reader 52 reading through the vertical window 48 of the bonnet 44 will capture the optical code in an image of the side surface 36 for decoding. Similarly, if the optical code is on the bottom surface 28 of the item 20, then the data reader 50 reading through the horizontal window 46 may capture the optical code in an image for decoding. Likewise, TDR 54 may also capture images and/or process optical codes along a top surface 26 of the item 20. If the optical code is on any of the remaining surfaces of the item 20, one or all data readers 50, 52, 54 (either individually or in combination) may capture image views bearing the optical code on the item 20 for decoding. For items 20 sold by weight, the item 20 is positioned on the platter 42 for weighing via the scale 164.

If the optical code is positively captured and decoded or if the item weight is accurately obtained, the data reading system 10 may emit a beeping (or other) sound indicating that the item 20 has been processed, and the customer 38 may proceed to the next item 20. Alternatively, the data reading system 10 may emit a different beeping (or other) sound indicating that the item 20 was not properly processed and present a message requesting that the customer 38 reprocess the item 20. Other feedback methods may also be provided, such as visual feedback (e.g., via an LED or an electronic display), indicating a successful read or an unsuccessful read.

In some embodiments, the data reading system 10 may include a display 158 (see FIG. 2) operable to display information, such as a running transaction list of the items 20 purchased, images, selectable icons, text, or other suitable information to facilitate the transaction. In some embodiments, the display 158 may show an image of a purchased item captured by the data readers 50, 52, 54 (or other cameras internal to the data reader housing), a list of purchase items and running costs, the weight of an item and the cost per pound of the item, or other suitable transaction information associated with the items 20. In some embodiments, the display 158 may be a touch screen that allows the customer 38 to interact directly with the screen (or via a stylus or other suitable instrument) to enter information and respond to prompts to allow the customer 38 to manage the transaction. The touch screen may be any of several suitable display types, such as an integrated liquid crystal (LCD) display, an organic light-emitting diode (OLED) display, or other display with suitable touch screen capabilities for detecting the customer's touch via a finger, stylus, or other suitable input device.

FIG. 2 is a simplified block diagram of another data reading system 100 according to an embodiment of the disclosure. As illustrated in FIG. 2, the data reading system 100 may be operably coupled with one or more of a power source 150, a top-down reader (also referred to as a “TDR”) 152, peripheral cameras 154, 156, a display 158, a remote server 160, and/or a point of sale (POS) system 162. Additional details of the data reading system 100 are described below.

With reference to FIG. 2, the data reading system 100 may be a bi-optic data reader having a vertical housing 110 and a horizontal housing 120 (arranged in a similar fashion as the data reader 10 of FIG. 1) in some embodiments. The data reading system 100 may be installed in a retail environment (e.g., grocery store), which typically is disposed within a counter or other support structure of an assisted checkout lane or a self-checkout lane. The vertical housing 110 provides an enclosure for one or more data readers 112, 114, 116, active illumination assemblies 118 (e.g., LED assemblies), and other optical elements (e.g., lenses, mirrors, etc.) and electrical elements (e.g., cables, circuit boards, etc.) therein. Similarly, the horizontal housing 120 provides an enclosure for one or more data readers 122, 124, 126, active illumination elements 128 (e.g., LED assemblies), a scale 164, and other optical elements (e.g., lenses, mirrors, etc.) and electrical elements (e.g., cables, circuit boards, etc.) therein. Bi-optic data readers tend to have a larger horizontal housing 120 as compared to the vertical housing 110, which provides space to support various components of the data reading system 100 and the scale 164 used to weigh produce or other items sold by weight or otherwise perform weighing of items when placed on the horizontal surface (often called a “weigh platter”).

In some embodiments, the vertical housing 110 and the horizontal housing 120 may be generally orthogonal to each other (including slightly angled orientations, such as being in the range of ±10° from orthogonal). Depending on the arrangement and orientation of the different opto-electrical elements, certain elements related to providing a horizontal field of view may be physically located within the vertical structure and vice versa.

In one embodiment, the data reading system 100 may include one or more different types of data readers, such as monochrome imagers and/or color imagers. For example, in one embodiment, data readers 112, 114 in vertical housing 110 may be monochrome imagers configured to capture monochrome images through the vertical window (e.g., window 48 of FIG. 1) of the data reading system 100. Likewise, data readers 122, 124 in horizontal housing 120 may be monochrome imagers configured to capture monochrome images through the horizontal window of the data reading system 100. Data reader 116 in vertical housing 110 may be a color camera module configured to capture color images through the vertical window of the data reading system 100. Likewise, data reader 126 in horizontal housing 120 may be a color camera module configured to capture color images through the horizontal window of the data reading system 100. Similarly, peripheral cameras 154, 156 may be either monochrome imagers and/or color imagers. In such embodiments, monochrome images may be analyzed (e.g., by a decoder) to decode one or more indicia (e.g., 1D barcodes, 2D barcodes, optical character recognition, digital watermarks, etc.), and color images may be analyzed (e.g., by an image processor) where color information may be particularly advantageous, such as produce recognition, item recognition or verification, and security analysis. Such analysis may be performed by local and/or remote processors that may contain an artificial intelligence (AI) engine or otherwise configured to perform other machine learning techniques.

The data reading system 100 may further include a main board 130 and a multi-port network switch 140. As shown herein, the main board 130 and the multi-port network switch 140 may be disposed within the horizontal housing 120 in one embodiment. It is contemplated that other embodiments may instead include the main board 130 and/or the multi-port network switch 140 within the vertical housing 110. In an embodiment where one of the multi-port network switch 140 or the main board 130 is disposed within the vertical housing 110 and the other is disposed within the horizontal housing 120, the two boards may be generally oriented orthogonal to each other similar to the orientation of the windows or another angled relationship (e.g., slightly angled orientations such as being in the range of ±10° from orthogonal). The ports may be at least somewhat aligned in the orthogonal direction or other arrangement to accommodate easy connection of network cables therebetween.

The main board 130 may be operably coupled with the data readers 112, 114 and the data readers 122, 124, such as via a communication interface (e.g., a MIPI interface) or other suitable interface. The main board 130 may have decoding software embedded therein and/or stored within internal memory 132 such that one or more on-board processors 135 may receive monochrome images to perform decoding on the optical indicia and provide the decoding result to a point of sale (POS) system 162 operably coupled thereto to complete a transaction. The one or more on-board processors 135 may also be configured to provide control (e.g., coordination or synchronization) of the various components of the system including camera exposure and timing of active illumination assemblies 118, 128 of the system. In addition, the one or more on-board processors 135 may also manage a boot sequence for initializing the data reading system 100 and for powering and configuring the various components of the data reading system 100 as further discussed with particular reference to FIG. 3. Suitable software and/or executable instructions for managing the boot sequence and other aspects of the data reading system 100 may be stored within internal memory 132 or another suitable location in communication with the processors 135.

Although a single block is shown representing one or more on-board processors 135, it is contemplated that some embodiments may include multiple processing components (e.g., microprocessors, microcontrollers, FPGAs, AI accelerator modules, etc.) configured with suitable instructions and programming to perform different tasks, alone or in combination, including object detection, system control, diagnostic and performance monitoring, optical code decoding, optical character recognition, artificial intelligence, machine learning analysis, and/or image processing techniques to support the functionality of the data reading system 100.

In one embodiment, the multi-port network switch 140 may be operably coupled to data reader 116, data reader 126, and with main board 130 located within the data reading system 100. Multi-port network switch 140 may also be operably coupled to the power source 150 as well as peripheral devices such as TDR 152, peripheral cameras 154, 156, display 158, the remote server 160, and/or a removable storage device 166. The number and types of peripheral devices may depend on a desired application within a retail environment. The TDR 152 may be configured as a stand connected to the data reading system 100 that typically provides a generally close overhead (angled) view of the read-zone to provide a top view of a product (as illustrated in FIG. 1) whereas internal data readers 112, 114, 116, 122, 124, 126 may be better suited for capturing images of the bottom and/or sides of the object within the read-zone. Additional TDRs are also contemplated as being connected to the data reading system 100. In some embodiments, peripheral cameras 154, 156 may be located remotely from the housing of the data reading system 100 such as being mounted on a ceiling or wall of the retail environment to provide additional views of the read-zone or checkout area. Such views may be useful for security analysis of the checkout area such as product verification, object flow, and human movements with the retail establishment. Such analysis may be performed by a remote service or other local devices (e.g., located on or otherwise coupled to the main board 130 or ethernet switch 140). Other peripheral devices may be located near the data reading system 100, such as a peripheral presentation scanner resting or mounted to a nearby surface, and/or a handheld scanner that also may be used for manual capturing by the user (e.g., checkout assistant or self-checkout customer). Such devices may be coupled directly to the main board 130 in some embodiments or to the multi-port network switch 140 if so enabled. As shown, the POS 162 may be coupled directly to the main board 130. Such a connection may be via communication interfaces such as USB, RS-232, or other such interfaces. In some embodiments, the POS 162 may be coupled directly to the multi-port network switch 140 if so enabled (e.g., as an Ethernet connected device).

The multi-port network switch 140 may be implemented on a separate board from the main board 130. In some embodiments, the multi-port network switch 140 may be implemented on the main board 130 that also supports the one or more processors 135. The multi-port network switch 140 may include a plurality of ports to provide advanced network connectivity (e.g., Ethernet) between internal devices (e.g., CCMs 116, 126) within the data reading system 100 and external devices (e.g., TDR 152, peripheral camera(s) 154, 156, display 158, remote server 160, etc.) disposed outside the vertical and horizontal housings 110, 120 of the data reading system 100. Thus, the multi-port network switch 140 may provide an Ethernet backbone for the elements within the data reading system 100 as well as for external devices coupled to the data reading system 100 for control and/or managing data flow or analysis. As an example, multi-port network switch 140 may be implemented with a KSZ9567 Ethernet switch or other EtherSynch® product family member available from Microchip Technology Inc of Chandler, Arizona or other similar products or devices configured to provide network synchronization and communication with network-enabled devices. Embodiments of the disclosure may include any number of ports supported by the multi-port network switch to couple to both internal devices (e.g., main board, cameras, etc.) and external devices (e.g., peripheral cameras, TDR, illumination sources, remote servers, etc.) to provide a flexible platform to add additional features for connecting with the data reading system 100.

Although FIG. 2 shows one block for active illumination assemblies 118, 128 in each of the vertical and horizontal housings 110, 120, some embodiments may include multiple such assemblies in each of the horizontal and vertical housings 110, 120 to provide for different lighting options at different angles across the read-zone. For example, the vertical housing 110 may include two (or more) illumination assemblies therein at different locations and/or different colors for a desired illumination field from the vertical view. Likewise, the horizontal housing 120 may include two (or more) illumination assemblies therein at different locations and/or different colors for a desired illumination field from the horizontal view. As shown herein, the illumination assemblies 118, 128 may be coupled directly to the main board 130. However, in some embodiments, additional components may be coupled within the path from the main board 130 such as a control panel or other such device. In yet other embodiments, the illumination assemblies 118, 128 may be coupled to the multi-port network switch 140 which may route triggering controls from the main board 130. TDR 152, one or more of the peripheral cameras 154, 156, and the display 158 may also include associated illumination assemblies to supporting functionality of the respective components. Synchronization of such illumination sources may be managed by the multi-port network switch 140 as controlled by the main board 130. In some embodiments, the multi-port network switch may employ or leverage IEEE1588 Precision Time Protocol to synchronize the illumination system with remote cameras, which may enable clock accuracy in sub-microsecond range.

In operation, images may be captured by the data readers 112, 114, 116, 122, 124, 126 (including TDR 152 and peripherals cameras 154, 156). Monochrome images may be captured by monochrome data readers 112, 114, 122, 124 and color images may be captured by color data readers 116, 126. Similarly, monochrome and/or color images may be captured by the TDR 152 and/or peripherals cameras 154, 156 depending on their configuration. The multi-port network switch 140 may be configured to coordinate (e.g., synchronize) timing of camera exposure and active illumination (e.g., white illumination) with the color data readers 116, 126 (as controlled by the controller on the main board 130) to occur in an offset manner with the timing of the camera exposure and active illumination (e.g., red illumination) with the monochrome data readers 112, 114, 122, 124.

Image data (e.g., streaming video, image frames, etc.) from the color data readers 116, 126 may be routed through the multi-port network switch 140 to the processing/analysis modules located internal to the data reading system 100 such as the one or more processors 135 supported by the main board 130. As such, image analysis (e.g., AI, machine learning, OCR, object recognition, item validation, produce recognition, analytics, etc.) may be performed on the color images internally within the data reading system 100 by the one or more processors 135 supported by the main board 130. In some embodiments, barcode decoding may also be performed on the captured color images internally within the data reading system 100 by the one or more processors 135 supported by the main board 130. Image data from the color data readers 116, 126 may also be routed through the multi-port network switch 140 to external devices, such as remote server 160 or other similar devices including any network enabled POS systems. As such, image analysis (e.g., AI, machine learning, OCR, object recognition, item validation, produce recognition, analytics, etc.) may be performed on the color images externally to the data reading system 100 by external devices coupled through the multi-port network switch 140. Such color images or other data stream may be routed directly to the network connected external devices through the multi-port network switch 140 without first being received by the main board 130 (if at all). In other words, image data may be communicated (e.g., passed) from at least one imager internal to the data reader through the at least one multi-port network device 140 and on to at least one external device bypassing the main board 130. Having a connection to both the main board 130 as well as to external devices via the multi-port network switch enables image data to be provided to internal as well as external processing resources. In some embodiments, data readers 116, 126 may have their own on-board processors configured to perform image analysis, decoding, and/or other pre-processing of the image data separate from, or in coordination with, processing done on the main board 130 or other remote systems.

Image data from the monochrome data readers 112, 114, 122, 124 may be provided to the main board 130 to the processing/analysis modules located internal to the data reading system 100 such as the one or more processors 135 supported by the main board 130. As such, barcode decoding may also be performed on the color images internally within the data reading system 100 by the one or more processors 135 supported by the main board 130. In some embodiments, image analysis (e.g., AI, machine learning, OCR, object recognition, item validation, produce recognition, analytics, etc.) may be performed on the monochrome images internally within the data reading system 100 by the one or more processors 135 supported by the main board 130. Image data from the monochrome data readers 112, 114, 122, 124 may also be routed through the multi-port network switch 140 to external devices, such as remote server 160 or other similar devices including any network enabled POS systems. As such, image analysis (e.g., AI, machine learning, OCR, object recognition, item validation, produce recognition, analytics, etc.) may be performed on the monochrome images externally to the data reading system 100 by external devices coupled through the multi-port network switch 140. Such monochrome images or other data stream may be routed directly to the network connected external devices to the multi-port network switch 140 after first being received by the main board 130.

Image data (e.g., streaming video, image frames, etc.) from the TDR 152 or other external peripheral cameras 154, 156 may also be routed through the multi-port network switch 140 to the processing/analysis modules located internal to the data reading system 100 such as the one or more processors 135 supported by the main board 130. As such, image analysis (e.g., AI, machine learning, OCR, object recognition, item validation, produce recognition, analytics, etc.) may be performed on the images (e.g., color and/or monochrome) internally within the data reading system 100 by the one or more processors 135 supported by the main board 130. In some embodiments, barcode decoding may also be performed on such images captured by the TDR 152 and other external peripheral cameras 154, 156 internally within the data reading system 100 by the one or more processors 135 supported by the main board 130. Image data from the TDR 152 or other external peripheral cameras 154, 156 may also be routed through the multi-port network switch 140 to external devices, such as the display 158, the remote server 160, point-of-sale system 162, or other similar devices including any network enabled POS systems. As such, image analysis (e.g., AI, machine learning, OCR, object recognition, item validation, produce recognition, analytics, etc.) may be performed on these images externally to the data reading system 100 by external devices coupled through the multi-port network switch 140. Such images or other data stream may be routed directly to the network connected external devices through the multi-port network switch 140 without first being received by the main board 130 (if at all).

The multi-port network switch 140 may be coupled to the main board 130 via a single cable configured to provide power and communication to the main board 130. Power may be provided to the system via power source 150 via the multi-port network switch 140, which in turn provides power (e.g., power over Ethernet (PoE)) to the main board 130 and the data readers 116, 126. Data readers 112, 114, 122, 124 and illumination assemblies 118, 128 may be powered via the main board 130.

Features of employing the multi-port network switch 140 as a primary backbone for communication and power to interface between both internal and external components of the system include enabling power, communications, and camera/illumination synchronization to occur over a single cable between such connected components. In addition, precision time protocol (PTP), generic precision time protocol (GPTP), time sensitive networking (TSN) may provide an improved synchronization (e.g., within 1 microsecond error) for an open standard, widely supported, single cable solution. In addition, scanner maintenance tools may be simplified via improved network connectivity.

FIG. 3 is a simplified illustration of a single-plane fixed data reading system 200 in accordance with one embodiment. It should be understood that the data reading system 200 may include many of the same internal components (e.g., processors, illumination sources, imagers, electronics, circuitry, etc.) operating in a similar fashion as described with reference to data reading systems 10, 100 of FIGS. 1-2. Accordingly, to avoid duplication and obscuring more pertinent features of the embodiment, such components are not further described herein in detail with the understanding that the prior description with reference to the embodiments of FIGS. 1-2 applies to the embodiment of FIG. 3 unless otherwise noted.

With reference to FIG. 3, the data reading system 200 includes a housing 202 having a scan window 204 through which one or more imagers 206 may capture image data of items 20a, 20b in a similar fashion as described previously with reference to FIGS. 1-2. The imagers 206 may include monochromatic imagers, color imagers, or combinations of the two. As illustrated in FIG. 3, the imagers 206 have a field-of-view 208 projecting outwardly through the scan window 204 and are operable to capture image data from the items 20a, 20b as the items 20a, 20b are swept across the field-of-view 208. Illumination sources 210 (which may include white LEDs, red LEDs, or other suitable light sources) disposed within the housing 202 help provide appropriate illumination to support the imagers 206 in acquiring sufficiently clear image data for subsequent processing and decoding of optical codes contained therein.

As generally illustrated in FIG. 3, in some examples, when the data reading system 200 is configured with the imagers 206 having a faster shutter speed (or short exposure time) and the illumination sources 210 are set with a short pulse width, the sweep speed for the item 20a is limited by the view width of the imagers 206 through the scan window 204 and the frame rate of the imagers 206. In such embodiments, the sweep speed of the item 20a across the field-of-view 208 may need to be slowed down to ensure the imagers 206 have sufficient time to clearly capture the target image data. On the other hand, imagers with a slower shutter speed (or a longer exposure time) and a longer illumination pulse width, the sweep speed for the item 20b may still be limited by the view width but may experience potentially significant motion blur issues depending on the frame rate.

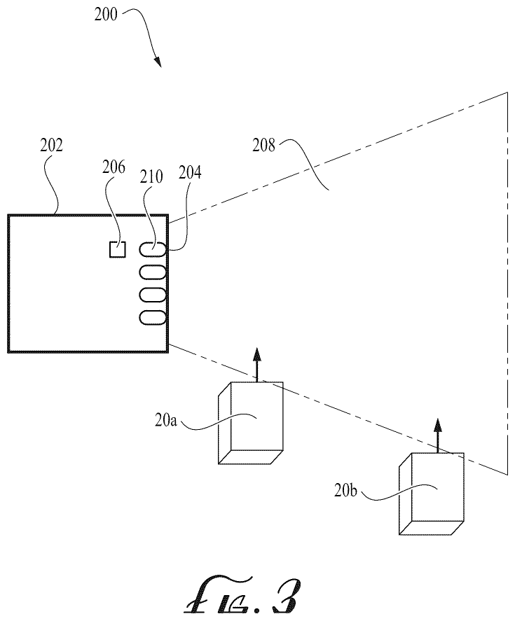

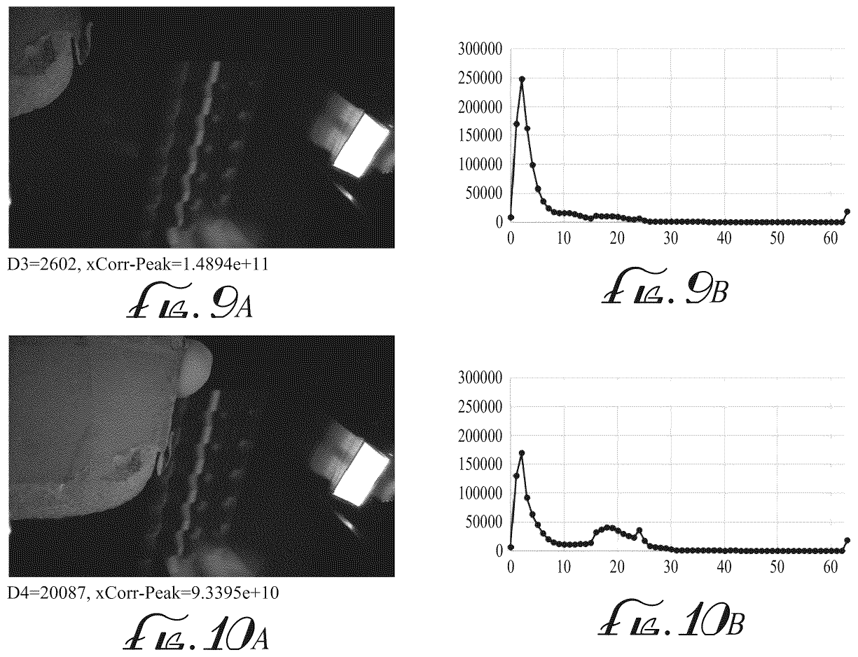

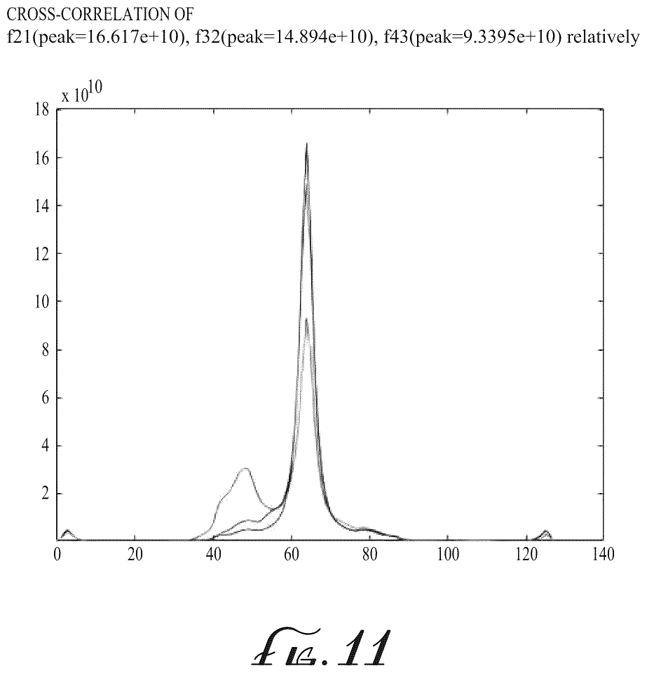

As noted previously, in some embodiments, the data reading systems 10, 100, 200 each include at least one imager configured to and capable of capturing image data for decoding optical codes (e.g., barcodes, optical character recognition, digital watermarks, etc.) present on an item 20. In some embodiments, the imager may be a monochromatic imager optimized for optical code reading, though in other embodiments the imager may be a color imager as well. Further, the data reading system 10, 100, 200 may be configured such that they are operable to monitor and control imager characteristics (e.g., frame rate, exposure time, etc.) and/or illumination characteristics (e.g., pulse width, frequency) to improve image acquisition at high item sweep rates, thereby providing a high first-pass read rate for item processing, while also minimizing overall power and processing loads of the data reading system 10, 100, 200. Additional details of these and other embodiments are provided with more detail below with particular reference to FIGS. 4-11.

FIG. 4 is an example timing diagram 400 charting image capture, illumination, and processing functionalities for the data reading systems 10, 100, 200 in accordance with one embodiment. For simplicity, the following discussion proceeds with reference to the example fixed, single plane data reading system 200 of FIG. 3, but it should be understood that the ensuing disclosure applies equally to and may be used in conjunction with the other data reading systems 10, 100 of FIGS. 1-2. With reference to FIG. 4, in one embodiment, the data reading system 200 is configured to operate in at least two different modes, which together are aimed at improving image acquisition and overall energy efficiency. The different operating modes allow the imagers 206 to toggle between image acquisition at a higher frame rate when an item is detected in the field-of-view 208 and thereafter switching to image acquisition at a lower frame rate for a pre-determined period to conserve overall processing load. Further examples of these features are provided below.

With reference to FIG. 4, after the data reading system 200 is activated, it may be initially set to operate in a first operating mode, referred to hereinafter as a monitoring mode. While in the monitoring mode, the imagers 206 are configured to capture images at a first high frame rate (e.g., 90 fps) with a fast shutter speed or exposure time (e.g., 50 μs) to help capture fast-moving items swept across the scan window 204 while mitigating potential motion blur issues. To support the image acquisition process, the illumination sources 210 may operate at 90 Hz with a pulse width matching the imager exposure time (e.g., 50 μs). In this configuration, the data reading system 200 may capture a first set of image data at a first frame, f₁, and attempt to decode any optical data therefrom. Thereafter, for a set number of frames, e.g., frames f₂ and f₃ in FIG. 4, the imager 206 may captured and buffer additional sets of image data without attempting to decode the image data from those frames. The data reading system 200 may continue this cycle of intermittingly capturing and decoding some image data while buffering other image data without analysis. For example, the captured image data at frame f₄ is decoded, but the captured image data at subsequent frame f₅ is captured but not decoded (see FIG. 4). The process continues with image data being captured and decoded for some frames at predetermined intervals while intervening frames are captured but not decoded to minimize computational load.

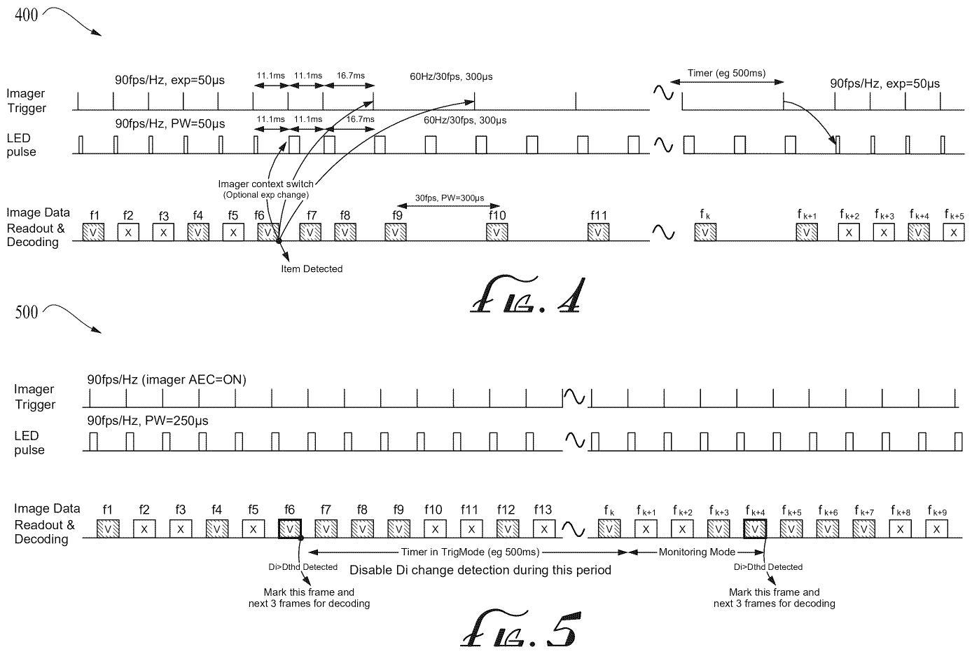

The above-referenced process continues until an item 20 is detected in a captured frame. Any suitable image analysis technique may be used to detect an item 20 in a captured frame, such as a histogram analysis as described in further detail below with reference to FIGS. 6-11. As illustrated in FIG. 5, once an item 20 is detected, the data reading system 200 is set to decode the current frame at which the item was detected (e.g., frame f₆ in FIG. 4), and to capture and decode image data for a determined set of frames following the current frame. In the example of FIG. 4, the data reading system 200 is set to capture image data and decode the next three successive frames, e.g., frames f₇, f₈, and f₉). Preferably, the image-acquisition parameters (e.g., imager frame rate, exposure time, illumination settings, etc.) are not changed during this capture and decode process while the data reading system 200 is in the monitoring mode.

Once the last of the predetermined number of frames has been captured and decoded, the data reading system 200 switches from the monitoring mode to a second operating mode, referred to hereinafter as a triggered mode. While in the triggered mode, the imager frame rate for capturing images is decreased to a second lower frame rate (e.g., 30 fps) and the pulse width of the illumination is also decreased (e.g., to 60 Hz) to conserve power. During the triggered mode, captured images may be buffered for decoding in the lower power operating mode until the pre-determined timeout period lapses. Once the period has lapsed, the data reading system 200 reverts to the monitoring mode for operation at the higher image rate as described previously. In some embodiments, the data reading system 200 may enter the triggered mode only if an optical code was not successfully decoded for the item 20 during analysis of the current frame and/or the successive frames.

As described, the embodiment of FIG. 4 aims at maximizing overall energy consumption by altering the image capture frame rate and illumination characteristics between the higher power monitoring mode and the comparatively lower power triggered mode. In other embodiments, such as illustrated in the timing diagram 500 of FIG. 5, the imager and illumination settings may instead remain constant between the monitoring and triggering modes. For example, with reference to FIG. 500, the imager 206 may have an image capture rate set at 90 fps with automatic exposure controls (AEC) on to automatically adjust exposure as needed for adequate image quality purposes. In such embodiments, the illumination pulse width may also be kept constant to maintain adequate intensity for the image acquisition process between the two modes without being too dim or too bright. The image capture process and decoding functionalities may otherwise proceed in a similar fashion as described above with reference to FIG. 4, wherein the imagers capture and decode image data from certain frames while others are buffered until an item is detected to configure the triggered mode. In some embodiments, while the data reading system 200 is in the timeout period of the triggered mode, the data reading system may not perform any image analysis on the captured frames (such as the histogram analysis discussed with below with reference to FIG. 6) to further minimize computational loads. In a similar fashion as the previous embodiment of FIG. 4, once the timeout period has elapse, the data reading system 200 may revert to the monitoring mode to continue the image acquisition process.

FIG. 6 illustrates an example method 600 for image acquisition and processing of the data reading systems 10, 100, 200 in accordance with one embodiment. For convenience and to avoid repetition, the following discussion proceeds primarily with reference to the data reading system 200 of FIG. 3, but it should be understood that the method 600 described with reference to FIG. 6 may apply equally to other data reading system configurations including the data reading systems 10, 100 of FIGS. 1-2. As described in further detail below with particular reference to method 600, the improved data reading systems 10, 100, 200 provide a streamlined design for capturing images at a high frame rate for decoding to maintain a high first pass read rate while minimizing overall processing loads and streamlining performance. The following description provides additional details of the method 600 in accordance with one embodiment.

Initially, the data reading system 200 is activated and operating is set to capture images in the monitoring mode. At step 602, the imager(s) 206 are configured to capture images at a first frame rate associated with the monitoring mode. In the illustrated example, the imager 206 are set to capture images at a frame rate of 90 fps and the illumination sources (e.g., Red LEDs) are set at 60 μs pulse width at 90 Hz. In other embodiments, one or more of these settings may be different for the data reader monitoring mode. At step 604, the imager 206 acquires an image of the field-of-view at frame fᵢ. At step 606, the captured image at frame fᵢ is buffered for decoding or skipping. As noted with reference to FIGS. 4-5, the data reading system 200 may selectively decode particular frames while skipping other frames to conserve processing load while operating in the monitoring mode.

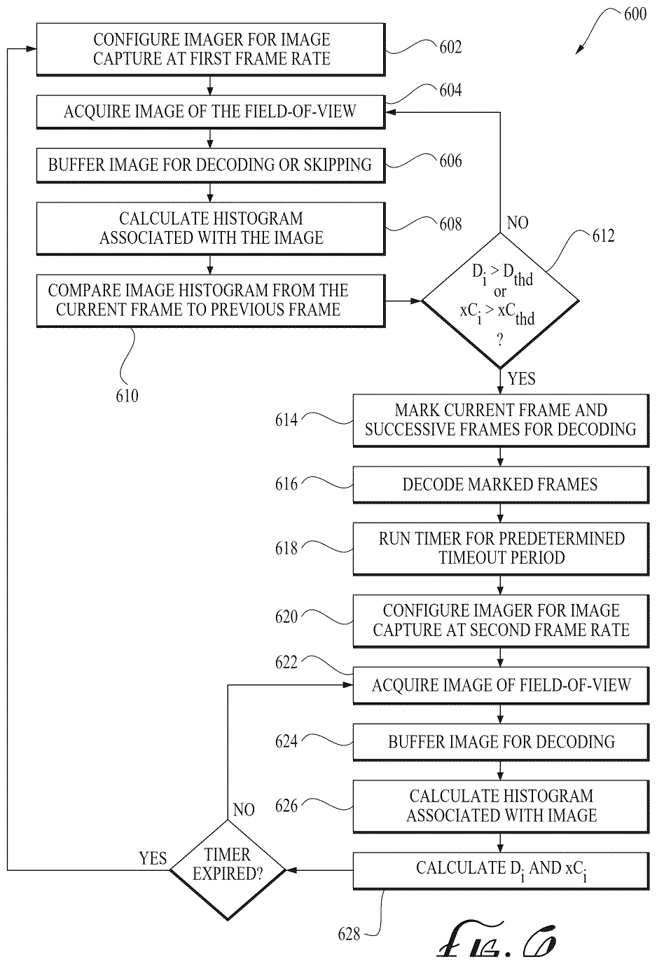

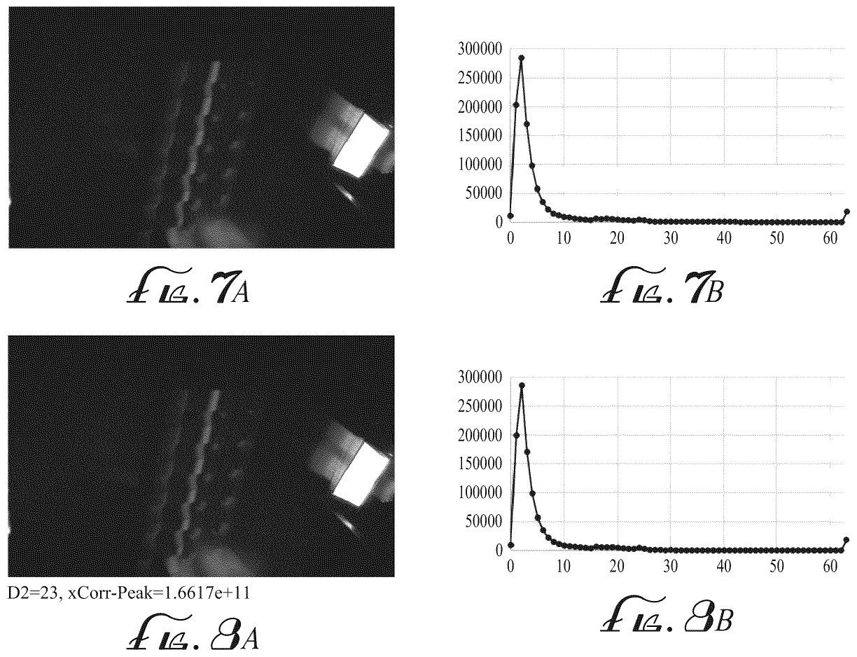

At step 608, the processor 135, and/or other suitable components of the data reading system 200, calculates a histogram of the current frame fᵢ from the captured image data. FIG. 7A is an example image captured at a current first frame f₁ in one embodiment, and FIG. 7B is an example histogram generated from the image data of the image in FIG. 7A. Similarly, FIGS. 8A-10B collectively illustrate additional examples of images and associated histograms for three successive frames, f₂, f₃, f₄, taken at subsequent times. The data reading system 200 buffers the current histogram for the current first frame f₁.

Thereafter, at step 610, the processor 135 compares image data between the currently captured frame, e.g., frame fᵢ, and a previous frame captured immediately before it, e.g., frame fᵢ₋ₜ, to determine whether there are any material differences between the images. In some examples, material differences between successive images may indicate the presence of an item in the current frame that was not present in the immediately previous frame. In such cases, the image analysis for the images is expected to reflect such differences.

Image data comparison may be performed using any one of several suitable image-analysis techniques. For example, in some embodiments, comparison step 610 may include a histogram analysis based on the captured images between two successive frames (e.g., frames f₁ and f₂ as illustrated in FIGS. 7A-8B). In one example embodiment, the image analysis may include a calculation to determine the distance between the respective histograms of the images captures at frame f₂ (i.e., the current frame) and frame f₁ (i.e., the immediately prior frame). In one example, the distance Dᵢ between the histograms may be calculated as follows:

$${D}_{i} = {\sum }_{b = 1}^{64} {( {H}_{( i , b )} - {H}_{( i - 1 , b )} )}^{2} / ( 1280 \times 800 )$$

where b is the histogram bin number (e.g., 64 bins) and using a 1200×800 sensor pixel resolution for normalizing Dᵢ.

In many embodiments, the histogram distance Dᵢ calculation is expected to accurately identify meaningful differences between the frames, where such differences likely reflect the presence of an item in the current frame. However, in some embodiments, environmental differences may lead to a false result, that is, the histogram distance Dᵢ calculation may be sufficient large so as to indicate the presence of an item between frames when there in fact is no such item present. For example, changes in ambient lighting between frames may result in a large histogram distance Dᵢ calculation such that one would expect the presence of an item.

Accordingly, in some example embodiments, a second comparison factor, such as a cross-correlation peak factor, relating to the image histograms may also be calculated to ensure that the calculated differences between the images are meaningful and not simply due to other factors, such as changes in ambient lighting or other environmental factors as noted previously. In one example, the cross-correlation peak factor, xCᵢ, may be calculated as follows:

$${xC}_{i} = crosscorrelation ( {H}_{( i , 1 : 64 )} - {H}_{( i - 1 , 1 : 64 )} )$$

where the histogram H is set to 64 bins and i indicates the current frame number. FIG. 11 illustrates example cross-correction xCi histogram data calculated for frames f₂ and f₁ (noted as f21), frames f₃ and f₂ (noted as f32) and frames f₄ and f₃ (noted as f43) in accordance with one embodiment (see also corresponding histograms of frames f₁, f₂, f₃, f₄ in FIGS. 7A-10B). After calculation of Dᵢ and xCᵢ, the data reading system 200 buffers the histogram distance Dᵢ and cross-correlation xCᵢ values.

At step 612, the processor 135 compares the calculated histogram distance Dᵢ between the current frame (e.g., frame f₂) and the preceding frame (e.g., frame f₁) to a stored threshold value D_{thd}. The processor 135 also compares the calculated cross-correction xCᵢ value between the current and preceding frames to a stored threshold value xC_{thd}. The threshold values may be determined in any number of suitable methods. For example, in one embodiment, the imagers may capture multiple frames without any items present in the field-of-view to establish a baseline. Thereafter, frames with items moving across the field-of-view of the imagers may be captured, including frames where the items are partially in view and others where the entire is fully captured in the images. A histogram analysis of the images may then be used to determine a suitable threshold value that indicates the presence of an item between successive frames. A similar process may be used to determine the threshold value for the cross-correction value xCᵢ.

Returning to FIG. 6, if neither Dinor xCᵢ exceed their respective threshold values D_{thd} or XC_{thd}, method 600 follows the “NO” branch and returns to step 604, where the imager 206 captures another image and the method 600 repeats the steps 606-612 described above. If at least one of Dᵢ or xCᵢ exceeds its respective threshold value, method 600 follows the “YES” branch and continues to step 614. As noted previously, in some embodiments, histogram distance Dᵢ may accurately detect the presence of an item via histogram analysis in most instances. Accordingly, the calculated cross-correction xCᵢ may not be necessary in some embodiments, and the method 600 may instead skip that calculation and analysis and proceed only with the histogram distance Dᵢ analysis in such embodiments.

At step 614, the current frame (e.g., frame f₆ in the example of FIG. 4) is marked by the processor 135 for decoding. The processor 135 also marks a select number of immediately successive frames for decoding. In the example of FIG. 4, the processor 135 marks the next three frames (e.g., frames f₇, f₈, f₉) for decoding. At step 616, the marked frames are processed and decoded (if an optical code is captured in the image set of any of the frames). In some embodiments, some of the select number of successive frames may not be decoded if the optical code for the item is processed and decoded in a previous frame in the set of successive frames. At step 618, the processor 135 sets and runs a countdown timer for a predetermined timeout period. In some embodiments, the timeout period may be 500 milliseconds but can be any suitable timeframe in other embodiments. During the timeout period, the data reading system 200 is automatically switched into triggered mode.

At step 620, the frame rate of the imagers is decreased to a second frame rate associated with the triggered mode of the data reading system 200, where the second frame rate is lower than the first frame rate described in step 602. In one example embodiment, the first frame rate is set at 90 fps and the second frame rate is set at 30 fps. It should be understood that in other embodiments, different frame rates for either or both the first and second frame rates may be used. In addition, the illumination sources may be set at a higher pulse width as compared with steps 602, 604. For example, the illumination sources may be set at a 250 μs pulse width at 60 Hz.

At step 622, the imager 206 acquires an image of the field-of-view at another frame (e.g., frame f₁₀ in the example of FIG. 4). At step 624, the captured image is buffered for decoding and thereafter processed to decode any optical codes contained in the image. At step 626, a histogram of the image is calculated and buffered. At step 628, the Dᵢ and xCᵢ values are calculated and buffered in a similar fashion as described previously with reference to step 610.

At step 630, the processor 135 determines whether the predetermined timeout period associated with the triggered mode has expired. If not, the method 600 continues along the “NO” branch and returns to the image capture step 622 and repeats the sequence of steps 622-630. If the processor 135 determines that the timeout period has elapsed, method 600 continues along the “YES” branch to repeat the process beginning at step 602 and revert the data reading system 200 back to the settings associated with the monitoring mode to continue the image acquisition and analysis process.

It should be understood that in other embodiments, certain steps described of method 600 of FIG. 6 may be combined, rearranged, altered, varied, and/or omitted without departing from the principles of the disclosed subject matter. For example, in some embodiments, the frame rate of the imager 206 and/or illumination settings for supporting the image capture process may not be altered between the monitored mode and the triggered mode. Accordingly, step 620 may be omitted in some embodiments. Similarly, as noted previously, in other embodiments, the method 600 may omit the calculation and use of the cross-correlation value xCᵢ and use only the histogram distance calculation Dᵢ for histogram analysis. In still other embodiments, the method 600 may omit the histogram generation at step 626 and/or omit the calculation of Dᵢ and xCᵢ values at step 628 during the triggered mode.

It is intended that subject matter disclosed in portion herein can be combined with the subject matter of one or more of other portions herein as long as such combinations are not mutually exclusive or inoperable. In addition, many variations, enhancements and modifications of the systems and methods described herein are possible.

The terms and descriptions used above are set forth by way of illustration only and are not meant as limitations. Those skilled in the art will recognize that many variations can be made to the details of the above-described embodiments without departing from the underlying principles of the invention.

1. A data reading system comprising:
a housing;
one or more data readers disposed within the housing, each of the one or more data readers having a field-of-view directed to a read region, wherein each data reader is operable to capture image data of an item as the item passes across the read region, each data reader capturing the image data a first image capture frame rate when in a first operating mode; and
a processor in operable communication with each of the one or more data readers, the processor configured to:
provide a first set of image data relating to a first frame to a decoding unit for decoding an optical code contained therein;
provide a second set of image data relating to at least one second frame to a memory for storage without decoding the second set of image data;
detect a presence of the item based on at least one of the first and second sets of image data;
mark a detection frame associated with the detected presence of the item;
responsive to the detection of the presence of the item, provide to the decoding unit for decoding: (1) image data associated with the marked detection frame; and (2) one or more third sets of image data relating to a select number of frames by the one or more data readers subsequent to the marked item detection frame; and
subsequent to providing the one or more third sets of image data, adjust the first operating mode of the one or more data readers to a second operating mode whereat each data reader is configured to capture subsequent image data at a second image capture frame rate.

2. The data reading system of claim 1, wherein the processor is further configured to start a timeout period associated with the second operating mode, and wherein the one or more data readers operate in the second operating mode during the timeout period.

3. The data reading system of claim 2, the processor further configured to toggle the second operating mode back to the first operating mode upon expiration of the timeout period.

4. The data reading system of claim 1, wherein the decoding unit decodes captured image data associated with the marked item detection frame and decodes the third set of image data for each frame of the select number of frames.

5. The data reading system of claim 1, wherein the processor is further configured to:
generate a histogram for one or both of the first set of image data and the second set of image data; and
analyze the histogram for the one or both of the first set of image data and the second set of image data to detect the presence of the item.

6. The data reading system of claim 5, wherein the processor is further configured to calculate a histogram distance for the histogram and compare the histogram distance to a threshold value to determine the presence of the item.

7. The data reading system of claim 5, wherein the processor is further configured to calculate a correlation factor for the histogram and compare the correlation factor to a threshold value to determine the presence of the item.

8. The data reading system of claim 1, wherein the decoding unit receives and decodes each set of image data captured by the one or more data readers during the second operating mode.

9. The data reading system of claim 1, wherein the first image capture frame rate of the first operating mode is equal to or higher than the second image capture frame rate of the second operating mode.

10. The data reading system of claim 1, further comprising one or more illumination sources disposed within the housing, wherein the one or more illumination sources are configured to provide illumination at a first pulse width during the first operating mode, and to provide illumination at a second pulse width during the second operating mode, wherein the first pulse width is equal to or shorter than the second pulse width.

11. A method of data reading via a data reading system, the method comprising:
configuring, via a processor, one or more data readers with a first image capture frame rate associated with a first operating mode;
capturing, via the one or more data readers operating in the first operating mode, a first set of image data of an item associated with a first frame;
decoding, via a decoding unit, the first set of image data to process any optical code contained therein;
capturing, via the one or more data readers operating in the first operating mode, a second set of image data of an item associated with a second frame;
storing, via the processor, the second set of image data without decoding the second set of image data;
detecting, via the processor, a presence of the item based on at least one of the first and second sets of image data;
marking, via the processor, an item detection frame associated with the detected presence of the item;
capturing, via the one or more data readers operating in the first operating mode, a third set of image data of an item associated with a select number of frames subsequent to the marked item detection frame;
decoding, via the decoding unit, image data associated with the marked detection frame and the third set of image data associated with the select number of frames;
configuring, via a processor, the one or more data readers with a second image capture frame rate associated with a second operating mode;
capturing, via the one or more data readers operating in the second operating mode, a fourth set of image data of the item; and
decoding, via the decoding unit, the fourth set of image data to process any optical code contained therein.

12. The method of claim 11, further comprising starting, via the processor, a timeout period associated with the second operating mode, wherein the one or more data readers continuously capture image data at the second image capture frame rate during the timeout period.

13. The method of claim 11, further comprising:
monitoring, via the processor, the timeout period; and
toggling, via the processor, the second operating mode back to the first operating upon expiration of the timeout period.

14. The method of claim 11, wherein the select number of frames includes at least a first select frame and at least a second select frame, and wherein the third set of image data includes at least a first select image data associated with the first select frame and a second select image data associated with the second select frame, the method further comprising:
decoding, via the decoding unit, one or both of the first select image data and the second select image data.

15. The method of claim 11, wherein detecting, via the processor, a presence of the item further comprises:
generating, via the processor, a histogram for one or both of the first set of image data and the second set of image data; and
analyzing, via the processor, the histogram for the one or both of the first set of image data and the second set of image data to detect the presence of the item.

16. The method of claim 15, further comprising:
calculating, via the processor, a histogram distance for the histogram; and
comparing, via the processor, the histogram distance to a threshold value,
wherein the step of marking the item detection frame is based on whether the histogram distance exceeds the threshold value.

17. The method of claim 15, further comprising:
calculating, via the processor, a correlation factor for the histogram; and
comparing, via the processor, the correlation factor to a threshold value, and wherein the step of marking the item detection frame is based on whether the correlation factor exceeds the threshold value.

18. The method of claim 15, further comprising decoding, via the decoding unit, each set of image data captured by the one or more data readers during the second operating mode.

19. The method of claim 11, wherein the first image capture frame rate of the first operating mode is equal to or higher than the second image capture frame rate of the second operating mode.

20. The method of claim 11, further comprising:
providing illumination, via one or more illumination sources, at a first pulse width during the first operating mode; and
providing illumination, via the one or more illumination sources, at a second pulse width during the second operating mode,
wherein the first pulse width is equal to or shorter than the second pulse width.
